(19) United States
(12) Patent Application Publication
(10) Pub. No.: US 2005/0072034 A1
(43) Pub. Date: Apr. 7, 2005

(54) Keg topping device

(75) Inventors: Robert M. Foster, Gainesville, FL (US); Brian Oen, Gainesville, FL (US)

Correspondence Address: ARENT FOX KINTNER PLOTKIN & KAHN, 1050 CONNECTICUT AVENUE, N.W., SUITE 400, WASHINGTON, DC, 20036, US

(73) Assignee: Keg Toppers Inc.

(21) Appl. No.: 10/686,702

(22) Filed: Oct. 17, 2003

Related U.S. Application Data
(60) Provisional application No. 60/418,700, filed on Oct. 17, 2002.

(51) Int. Cl. G09F 3/10; G09F 3/00

(52) U.S. Cl. 40/673; 40/306

(57) ABSTRACT

A keg topping device for emplacing an advertising component on top of a keg includes a flat disc surface with an opening therein to fit the device around the mouth of a keg. The opining in the disc forms an inner rim, the perimeter of which, can be fastened to the base around the mouth of the keg by an adhesive. The advertising component is disposed on a surface of the disc member, and in place on the keg, is exposed to view from above. The surface of the disc member, surrounding the opening, is a continuous surface that is free from perforations.

This application claims priority to U.S. provisional patent application Ser. No. 60/418,700, entitled KEG TOPPER, filed on Oct. 17, 2002, the contents of which are incorporated herein by reference.

### BACKGROUND OF THE INVENTION

1. Field of the Invention

This invention relates to an advertising medium. More specifically, the present invention relates to an advertising medium in the form of a keg topping device for displaying an advertising message on top of a keg of beer or other keg beverage.

2. Description of the Related Art

Advertising is the life-blood of any commercial business entity. Without advertising, a business would not have access to potential customers or business associates that could purchase goods from or use the services provided by the business. As a result, a business could not be as profitable and successful in its market without advertising. In addition, any organization, group, or club that seeks to inform the public about its services would have a need to advertise. Therefore, advertising provides visibility that is critical to the survival or objectives of a business entity or organization.

Advertising through radio, television, flyers, or billboards, although reaching large markets, is fleeting. Further, there is a disadvantage in the existing advertising methods, in that radio and television advertisements are expensive and only last for about 30 seconds. Any advertising benefit derived from this form of advertisement is often realized only after the public has been exposed to it numerous times, which can be cost prohibitive to many businesses. Flyers are often randomly handed out to the general public, rather than to a target audience that may have a need for the services or products of the business. Billboards, may have even shorter exposure to the public, as this medium generally stays in memory only as long as it takes a viewer to pass it by.

Therefore, there is a need for an improved method and device for advertising to a target audience.

### SUMMARY OF THE INVENTION

The present invention relates to a keg topping device for providing a full color placement of an advertiser's message to a target audience over an extended period of time. Among other things, the keg topping device allows a business or organization to provide a repeat and long-lasting exposure of a particular message to a target market.

The advertising medium, in an embodiment of the present invention, is a keg topping device. One example of the keg topping device is a display device for the top end surface of a keg of beer or other keg beverage. The keg topping device displays a business or organization's advertising message so that individuals who fill and refill their beverage containers (e.g., cups) from the keg would have frequent exposure to the advertisement over a short period of time, for example, during a sporting event. The regular advertisement of a business entity's message over a limited period of time can serve to keep the advertisement in the forefront of the target audiences' mind.

Further, since the nature of the keg invites individuals to socialize in its proximity, the keg topping device provides repeat and longer-term exposure to the advertiser's message than a 30 second radio or television advertisement. For example, college students who read college papers to find activities for the weekend are often the same college students that would be staring down at the keg topping devices. However, not only beer consumers, and college students, but other individuals in proximity of the keg topping device, may be exposed to the advertising message.

The advertising message can be related to the contents of the keg; however, the advertising message is not limited in this manner. A variety of advertising is possible with the keg topping device. An advertisement from any business entity, such as a restaurant, apartment complex, convenience store, or bookseller, can benefit from the advertising exposure that the keg topping device provides.

Accordingly, a basic design of the keg topping device is for clearly displaying a company's message. Although many additional uses can be made out of the keg topping device, such as Frisbees® or wall ornaments, its primary specific use is for advertising on top of kegs. The keg topping device is designed for placement on top of the keg around or beside the mouth of the keg. The width of the keg topping device can vary from 1 inch to 16 inches, depending on the needs of the advertiser.

Many different materials can be used in the production of the keg topping device. Hard plastics can be used to form a flat surface on top of the keg that is also thus usable for other purposes, such as a shelf, or the device can be made out of more pliable materials, such as vinyl-based materials, which may be used to conform the device to the convex top of the keg. A variety of paper can also be used for the keg topping device, such as 20 lb or 40 lb stock paper, or photography paper. If warranted, adhesive paper can be used to stick the keg topping device onto the keg. Further, a clear laminate can be applied to the surfaces of the material of the keg topping device to prevent spills from damaging the graphical image of the advertisement, so that the device can be reused.

The keg topping device is not limited to only a circular shape. An endless number of shapes are possible for the keg topping device, including simple shapes (e.g., triangles, squares, diamonds, and rectangles) and more complex shapes (e.g., the shape of a company's logo).

The keg topping device is not limited to only standard beer kegs. It can also fit Party Ballz™, ¼ barrel kegs, ⅙ barrel kegs, and any other size barrels. In order for the keg topping device to stay in place, in one embodiment, a slit or slits are formed or cut about the opening of the device, ensuring the stabilization of the keg topping device about the mouth of the keg. Other methods and devices usable with the keg topping device to stabilize it on the top of the keg include a permanent adhesive, a non-permanent adhesive, a weight system, and other features for placing the device on the keg upper surface or about the mouth of the keg. Materials usable for such adhesive or other attachment include foam, glue, magnets, static charged materials, and adhesives.

An almost endless combination of coloring can be used in the decorative art and graphic design of the keg topping device, and a wide variety of colors and textures can be used in accordance with the desired use of the customer. The many sizes, shapes, and colors of the keg topping device make the possibilities of advertising, branding, or naming a product practically endless.

Additional advantages and novel features of the invention are set forth in the attachments to this summary, and in part will become more apparent to those skilled in the art upon examination of the following or upon learning by practice of the invention.

### BRIEF DESCRIPTION OF THE DRAWINGS

The features of the invention will be more readily understood with reference to the following description and the attached drawings, wherein:

FIG. 1 illustrates a perspective view of an example keg for use in accordance with the present invention;

FIG. 2 illustrates a top view of an example keg for use in accordance with the present invention;

FIG. 3 illustrates an example of a keg topping device in accordance with the present invention;

FIG. 4 illustrates a comparative diagram of keg topping devices having different dimensions in accordance with embodiments of the present invention;

FIG. 5 illustrates a perspective view of an example keg with the example keg topping device emplaced thereon in accordance with the present invention; and

FIG. 6 illustrates a view of an example keg with the example keg topping device of the present invention emplaced thereon.

### DETAILED DESCRIPTION OF THE INVENTION

The present invention is directed to a keg topping device for displaying an advertisement. The keg topping device of the present invention can be used to expose a target audience, such as, college students and sports fans who tend to socialize around a keg during an event, to a particular advertiser's message. The socialization around the keg and refilling of individual beverage containers from the keg, provides the target audience with frequent exposure to the advisement over a short period of time, thus meeting the advertising goals of the advertiser.

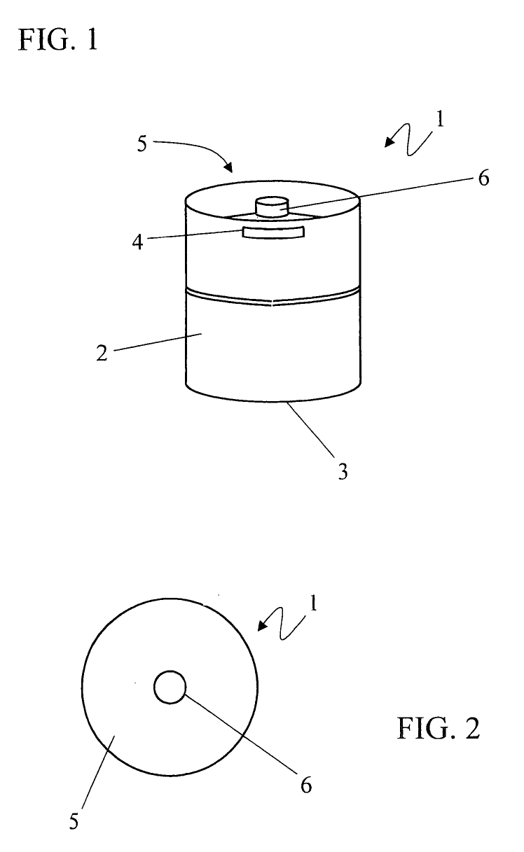

As shown in the perspective view of FIG. 1, a keg 1 includes a body 2, bottom 3, handle portion 4, upper surface 5, and mouth 6. FIG. 2 presents a view of the top end 5 of the keg 1, showing the mouth 6. As discussed above, the present invention can be applied to a keg of any size, as well as Party Ballz™ or any other size gallon barrels.

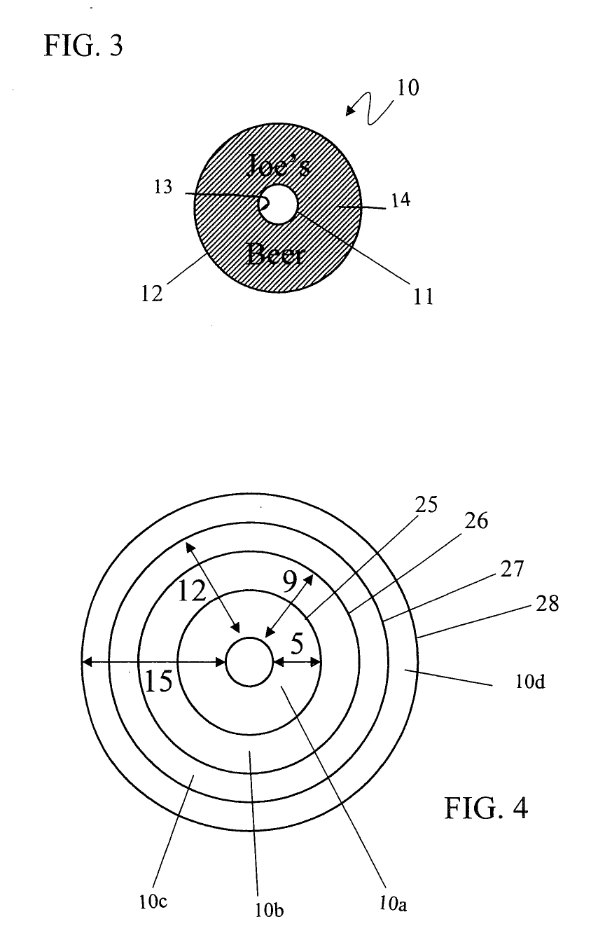

FIG. 3 illustrates an overhead view of an example keg topping device 10 with the graphic design or advertisement for “Joe's Beer,” in accordance with an embodiment of the present invention. However, the advertisement is not limited to the contents of the keg. The advertisement can be directed to a business or organization unrelated to the contents of the keg. As shown in FIG. 3, the keg topping device 10 can be a disc member 14 that includes an opening 11 for fitting the device 10 about the mouth of a keg, and an outer edge 12, defining the outer circumference of the example circular keg topping device 10 shown. The opening 11 in the keg topping device 10 forms an inner rim 13.

In one embodiment of the present invention, the surface of the keg topping device 10, surrounding the opening 11, is a continuous surface that is free from perforations. In another embodiment of the present invention, the surface of the device 10, surrounding the opening 11, includes a slit or plurality of slits to help stabilize the device about the mouth 6 of the keg 1.

FIG. 4 presents a comparative diagram showing superimposed example circular keg topping device dimensions, in accordance with an embodiment of the present invention. In the examples shown in FIG. 4, the dimensions of each keg topping device 10a, 10b, 10c, 10d include a center opening 11. A first example keg topping device 10a has a span of 5 inches between the outer edge 25 of the first keg topping device 10a and the opening 11. The second example keg topping device 10b has a span of 9 inches between the outer edge 26 of the second keg topping device 10b and the opening 11. The third example keg topping device 10c has a span of 12 inches between the outer edge 27 of the third keg topping device 10c and the opening 11. The fourth example keg topping device 10d has a span of 15 inches between the outer edge 28 of the fourth keg topping device 10c and the opening 11. Accordingly, the keg topping device can be sized to fit any size barrel or keg.

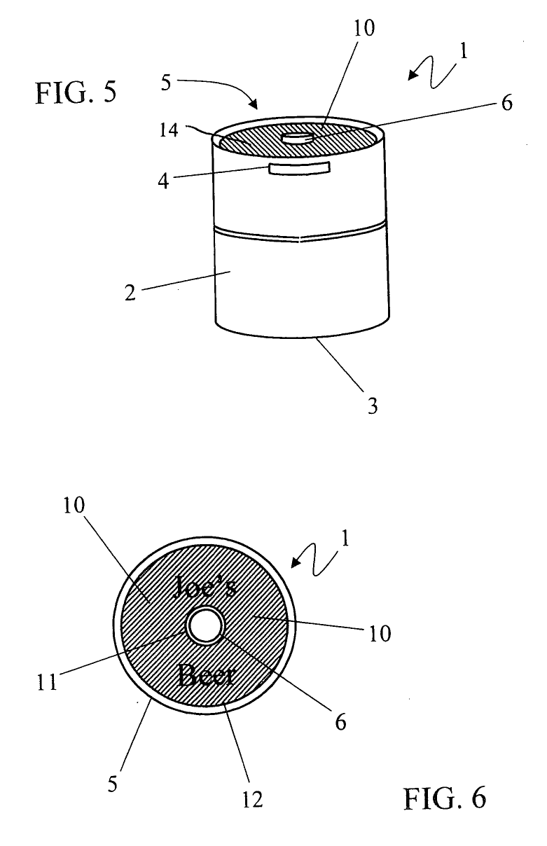

FIGS. 5 and 6 contain views of an example keg 1 with the example keg topping device 10 of FIG. 3 emplaced on the keg 1. As shown in FIG. 5, the keg topping device 10 fittably attaches to the keg 1 at the top end 5, as shown in FIG. 5, about the keg mouth 6. FIG. 6 illustrates a top view of the keg topping device 10 emplaced about the keg mouth 6.

In one embodiment of the present invention the basic design of the keg topping device is a disc member 14, such as a circle. The disc member 14 can be flat as shown in FIG. 5 to accommodate a top end 5 that is flat, or convex in order to conform to a convexly curved top end 5 as shown in FIG. 1. The keg topping device can be placed on top of the keg, around or beside the mouth of the keg. The width of the keg topping device can vary from 1 inch to 16 inches, depending on the needs of the advertiser.

The keg topping device is not limited to only a circular shape. The device can be formed in any number of shapes, including simple shapes (e.g., triangles, squares, diamonds, and rectangles) and more complex shapes (e.g., the shape of a company's logo).

The materials that can be used to form the keg topping device include hard plastics that can be used to form a flat surface on top of the keg, so that the keg topping device can also serve as a shelf. The device 10 can also be made out of pliable vinyl-based materials. Pliable material can conform the device to the convex top end surface 5 of the keg 1. More pliable materials can be used in circumstances where the top end surface 5 of the keg is convex. Paper products can also be used for the keg topping device. In one example of the present invention, photography paper can be used. Photography paper, on which the advertisement is arranged, provides a more realistic graphical design. If warranted, adhesive paper can be used to stick the keg topping 10 device onto the keg 1.

Once the advertising image has been placed on the device, the member can be laminated with a clear laminate to protect the surfaces and the underlying advertisement from damage due to spills, tears, or any other elements. By protecting the keg topping device with a laminate or other protective covering, the keg topping device can be used for longer periods of time and reused.

The keg topping device can be made by feeding the paper, or other material into a punching machine to cut-punch the material into the desired shape. Other shaping means can be employed in order to produce the desired shape.

In order for the keg topping device to stay in place, in one embodiment, a slit or slits are formed or cut about the opening of the device, ensuring the stabilization of the keg topping device about the mouth of the keg.

Additional methods and devices can be used to stabilize the keg topping device thereby securing the device on the top surface of the keg. Such fastening means include a permanent adhesive, a non-permanent adhesive, a weight system, and other features for placing the device on the keg upper surface or about the mouth of the keg. Materials usable for such adhesive or other attachment include foam, glue, magnets, statically charged materials, and adhesives. In operation, an adhesive can be placed on a surface of the disc member 14 opposite from the surface of the advertisement. In one embodiment of the present invention, the adhesive can be placed on the perimeter of the inner rim 13 of the disc member 14.

The present invention also includes a method of mounting the keg topping device 10 onto a top end 5 of the keg 1. The device can be mounted onto a keg, such as that illustrated in FIG. 1, having a top portion 5 with a protruding mouth 6. The opening of the disc member 14 can be positioned at an angle over the protruding mouth 6. Then, the disc member 14 can be lowered so that the inner rim 13 of the opening 11 circumscribes the mouth 6. The disc member 14 is then emplaced on an upper surface of the keg at the top end surface 5 so that the advertisement is exposed to view. Emplacing the disc member on an upper surface of the container around a mouth thereof includes fastening a perimeter of the inner rim 13 to a base portion around the mouth 6 with an adhesive. The outer edge 12 of the disc member 14 is smoothed around the base of the mouth 6. The disc member can also be slid at an angle over the protruding mouth of the keg and the outer edge 12 of the disc member can be smoothed onto the top surface 5 of the keg 1 to complete the display.

The method of mounting the keg topping device to the keg allows the advertisement to be seen by a target audience who socialize around the keg during an event. The target audience would be able to view an advertisement superimposed onto a disc member.

The graphic design of the device can employ an almost endless combination of colors. For example, keg topping devices of the present invention, formed from photography paper, can be as colorful and decorative graphic art designs. Further with a well as any graphic art design, an immeasurable variety of colors and textures can be used as part of the advertisement on the keg topping device depending on the advertiser. Textures can include protrusions from the surface of the device in order to draw attention to a particular feature of the advertisement. The many sizes, shapes, and colors of the keg topping device make the possibilities of advertising, branding, or naming a product practically endless.

Example embodiments of the present invention have now been described in accordance with the above advantages. It will be appreciated that these examples are merely illustrative of the invention. Many variations and modifications will be apparent to those skilled in the art.

1. A keg topping device for emplacing on a top end of a keg, around a keg mouth, comprising:
a disc member having an opening forming an inner rim; and
a graphic design disposed on a surface of the disc member, and exposed to view,
wherein the surface of the disc member, surrounding the opening, is a continuous surface.

2. The device according to claim 1, wherein the disc member is flat.

3. The device according to claim 1, wherein the disc member has a convex shape.

4. The device according to claim 1, wherein the disc member is formed from a hard plastic.

5. The device according to claim 4, wherein the disc member is formed to serve as a shelf.

6. The device according to claim 1, wherein the disc member is formed from photography paper.

7. The device according to claim 1, wherein the disc member is formed from a vinyl-based material.

8. The device according to claim 1, wherein the disc member is formed from a magnet.

9. The device according to claim 1, wherein the surface of the disc is textured.

10. The device according to claim 1, wherein the graphic design comprises an advertising component.

11. The device according to claim 1, wherein the disc member is attached to the keg by a fastening feature selected from a group consisting of foam, glue, magnets, and statically charged materials.

12. The device according to claim 11, wherein the graphic design is disposed on a first surface of the disc member and an adhesive is disposed on a second surface of the disc member, the second surface being opposite to the first surface.

13. The device according to claim 1, wherein the disc member has an adhesive on an inner rim that fixedly attaches a perimeter of the inner rim to an outer surface of the keg mouth.

14. The device according to claim 1, wherein the disc member comprises an adhesive portion on a surface opposite from the graphic design.

15. The device according to claim 1, wherein the disc member comprises a shape representative of an advertising logotype.

16. The device according to claim 1, wherein the disc member comprises weights to stabilize the member on the upper surface of the keg.

17. The device according to claim 1, wherein the disc member comprises a laminate disposed on at least one surface thereof.

18. The device according to claim 17, wherein the laminate is disposed on the graphic design.

19. A keg topping device for advertising on a top end surface of a keg, the device comprising:
a flat disc member having opposing surfaces and a centrally located opening; and
an advertising component superimposed on the disc member,
wherein the opposing surfaces of the disc member are free from perforations.

20. A method of mounting a disc member onto a top end of a container, the disc member having an opening therethrough forming an inner rim and a smooth continuous surface around the inner rim, wherein a graphic design is superimposed on a first surface of the disc member, the method comprising:
providing a container for filling with a predetermined commodity, having a top portion with a protruding mouth;
positioning the opening of the disc member at an angle over the protruding mouth of the container;
lowering the disc member so that the inner rim of the opening circumscribes the protruding mouth;
emplacing the disc member on an upper surface of the container at the top end so that the graphic design is exposed to view; and
smoothing an outer edge of the disc member around a base of the protruding mouth.

21. The method according to claim 20, wherein emplacing the disc member on an upper surface of the container around a mouth thereof, comprises:
fastening a perimeter of the inner rim to a base around the protruding mouth with an adhesive.

22. A method of advertising on a keg having a top surface and a keg mouth protruding from the top surface, the method comprising:
providing an advertisement superimposed onto a disc member, the disc member having a smooth continuous surface surrounding an opening therethrough, and an outer edge;
positioning the advertising component to be exposed to view;
sliding, at an angle, the opening of the disc member over the protruding mouth of the keg; and
smoothing the outer edge of the disc member onto the top surface of the keg.
